(19) United States
(12) Patent Application Publication
(10) Pub. No.: US 2013/0208502 A1
(43) Pub. Date: Aug. 15, 2013

(54) SPREAD ILLUMINATING APPARATUS

(71) Applicant: MINEBEA CO., LTD., (US)

(72) Inventor: Daisuke NAKAYAMA, Fukuroi-shi (JP)

(73) Assignee: MINEBEA CO., LTD., Kitasaku-gun (JP)

(21) Appl. No.: 13/760,664

(22) Filed: Feb. 6, 2013

(30) Foreign Application Priority Data
Feb. 9, 2012 (JP) 2012-026350

(51) Int. Cl. F21V 8/00

(52) U.S. Cl. CPC G02B 6/0018
USPC 362/608

(57) ABSTRACT

A spread illuminating apparatus includes: a point light source; a light guide plate; a brightness distribution control lens that controls a spread angle of light emitted from the point light source; and a Fresnel lens that adjusts the spread angle making light to advance along an optical axis in the light guide plate. Multiple prisms extend along a lengthwise direction of an incident light surface and are formed on an emitting surface of the light guide plate or a surface opposite to the emitting surface, and at least some certain prisms in the multiple prisms are formed as that a ratio of the prism depth relative to the thickness of the light guide plate is larger at a side portion of the point light source than at a front portion of the point light source.

### BACKGROUND OF THE INVENTION

1. Field of the Invention

The present invention relates to a spread illuminating apparatus, and in particular, a spread illuminating apparatus with narrow directivity that is suitable as a backlight for a liquid crystal display device.

2. Description of the Related Art

Currently, a sidelight-type spread illuminating apparatus using a point light source (for example, a white LED) is widely used as a backlight for transmissive-type (or semi-transmissive type) liquid crystal display devices. This type of spread illuminating apparatus includes a flat light guide plate having a principal surface that is approximately the same size with a screen and a point light source arranged on a side end surface of the light guide plate. Light is introduced from the side end surface of the light guide plate and emitted from one of the principal surfaces. The screen is thus uniformly illuminated.

In such a spread illuminating apparatus, the following problem is conventionally known. That is, supposing light introduced from the point light source has a wide angular distribution, this eventually causes light to be emitted with a wide angular distribution from the light guide plate. Accordingly, it makes sufficient brightness to be difficult to achieve for bad directivity. In order to overcome this problem, a spread illuminating apparatus using a Fresnel lens has been proposed (for example, Japanese Patent Application Laid-Open (JP-A) No. 2007-73469).

The spread illuminating apparatus disclosed in JP-A No. 2007-73469 is shown in FIG. 11. The spread illuminating apparatus 100 shown in FIG. 11 includes a light guide plate 111, LEDs 112, and a light collector 113. The LEDs 112 face an incident light surface 111c of the light guide plate 111 via the light collector 113. A linear Fresnel lens 114 consisting of a prism group extending in a thickness direction of the light guide plate 111 is provided corresponding to each LED 112 on a side surface 113c of the light collector 113 that faces the incident light surface 111c of the light guide plate 111. A width dimension d between the side surface 113c and a side surface 113d of the light collector 113 is formed so that it approximately corresponds to the focal length of the linear Fresnel lens 114.

In the spread illuminating apparatus 100, light P that has been emitted radially from the LEDs 112 is refracted by the operation of the linear Fresnel lens 114 and collected, and then converted into approximately parallel light P′ within an xy plane. Thus, the light distribution within a plane (xz plane) that is parallel to the incident light surface 111c of light emitted from an emitting surface 111a of the light guide plate 111 is narrowed (realizing narrow directivity).

### SUMMARY OF THE INVENTION

However, although the spread illuminating apparatus 100 shown in FIG. 11 can achieve narrow directivity as described above, it needs to be improved yet in the uniformity of the brightness. Since the light P′ advances inside the light guide plate 111 approximately parallel, the light P′ is not easily mixed in a direction parallel to the incident light surface 111c. Thus, non-uniformity in the brightness distribution of light that has been introduced from the incident light surface 111e becomes readily reflective as non-uniformity in the brightness distribution of light td be emitted from the light guide plate 111. In a point light source such as a white LED, brightness at the front surface is generally the highest, and brightness decreases toward the periphery. Therefore, particularly in a case in which a plurality of white LEDs 112 are disposed in a direction parallel to the incident light surface 111c as shown in FIG. 11, there has been a problem in that unevenness in the brightness, in which the brightness is high in the front surface direction of the LEDs 112 but the brightness is low between the LEDs 112, may become prominent in the light emitted from the light guide plate 111.

Considering the above problems, an object of the present invention is to provide a spread illuminating apparatus using a point light source and a light guide plate that is capable of obtaining illumination light with narrow directivity and excellent brightness uniformity.

The below-described embodiments exemplify constitutions of the present invention, and will be explained in an itemized manner in order to facilitate the understanding of the various constitutions of the present invention. Each item is not meant to limit the technical scope of the present invention, and substitutions or deletions of a portion of the constituent elements of each item as well as additions of other constituent elements upon referring to the detailed description of the preferred embodiments are included within the technical scope of the invention.

In order to achieve the object described above, according to a first aspect of the present invention, there is provided a spread illuminating apparatus comprising: a point light source; a light guide plate having an incident light surface on which the point light source is arranged and an emitting surface that emits light; a brightness distribution control lens that controls a spread angle of light emitted from the point light source; and a Fresnel lens that adjusts the spread angle making light to advance along an optical axis in the light guide plate, wherein multiple prisms extend along a lengthwise direction of the incident light surface and are formed on the emitting surface of the light guide plate or a surface opposite to the emitting surface, and at least some certain prisms in the multiple prisms are configured as that a ratio of the prism depth relative to the thickness of the light guide plate is adapted to be larger at a side portion of the point light source than at a front portion of the point light source.

According to this structure, the spread illuminating apparatus includes a brightness distribution control lens that controls a spread angle of light emitted from the point light source and a Fresnel lens that adjusts the spread angle making light to advance along an optical axis in a light guide plate. Thereby, illumination light with narrow directivity and excellent brightness uniformity can be obtained.

Further, according to this structure, the light guide plate is formed as that a ratio of the prism depth, at least some of the multiple prisms, relative to the thickness of the light guide plate is made larger at a side portion of the point light source than at a front portion of the point light source. Thereby, the brightness uniformity of the illumination light can be further improved.

In the first aspect of the present invention, the multiple prisms contain at least some certain prisms whose depth changes to satisfy that a side portion of the point light source is adapted to be deeper than a front portion of the point light source.

In the first aspect of the present invention, the change in the prism depth forms a sine curve.

In the first aspect of the present invention, the thickness of the light guide plate changes along a ridge line of the prism to satisfy that a side portion of the point light source is adapted to be thinner than a front portion of the point light source.

In the first aspect of the present invention, the change in the thickness of the light guide plate along the ridge line of the prism forms a sine curve.

In the first aspect of the present invention, the brightness distribution control lens each has one recessed portion which penetrates in the thickness direction of the brightness distribution control lens, the recessed portion being located at a place facing the point light source.

In the first aspect of the present invention, a cross section of the recessed portion orthogonal to the thickness direction of the brightness distribution control lens forms a semi-ellipse, and a center axis of the recessed portion corresponds to an optical axis of the point light source.

In the first aspect of the present invention, the Fresnel lens is formed on the incident light surface of the light guide plate.

In the first aspect Of the present invention, the Fresnel lens is a Fresnel-TIR compound Fresnel lens.

With the above-described structures, the present invention can provide a spread illuminating apparatus including a point light source and a light guide plate having an incident light surface on which the point light source is disposed and an emitting surface that emits light, which is capable of obtaining illumination light with narrow directivity and excellent brightness uniformity.

### BRIEF DESCRIPTION OF THE DRAWINGS

FIG. 1A is a perspective view illustrating the essential parts of a spread illuminating apparatus according to a first embodiment of the present invention, and FIG. 1B is a cross-section view along line A-A of the spread illuminating apparatus shown in FIG. 1A;

FIG. 2 is an enlarged plan view illustrating the vicinity of an incident light surface of the spread illuminating apparatus shown in FIG. 1;

FIG. 3 is a schematic view showing an operation of a Fresnel lens in the spread illuminating apparatus shown in FIG. 1;

FIG. 4 is a graph illustrating the directivity of emitted light in the spread illuminating apparatus shown in FIG. 1;

FIG. 5 is a graph showing the brightness uniformity of emitted light in the spread illuminating apparatus shown in FIG. 1;

FIG. 6 provides views showing the brightness distribution on an emitting surface of a light guide plate as a light/dark distribution in a spread illuminating apparatus including a Fresnel lens and a brightness distribution control lens, and FIG. 6A illustrates a case in which multiple prisms do not include prisms in which the depth changes as a comparative example while FIG. 6B illustrates the case of the spread illuminating apparatus according to the first embodiment of the present invention;

FIG. 7 is a graph illustrating light advancing in a forward direction of a point light source and a light distribution in a thickness direction of the light guide plate of the light progressing to a lateral portion of the point light source in a spread illuminating apparatus including a Fresnel lens and a brightness distribution control lens;

FIG. 8 is a cross-section view illustrating another example of the multiple prisms along the same cross-section as in FIG. 1B in the spread illuminating apparatus according to the first embodiment of the present invention;

FIG. 9A is a perspective view illustrating the essential parts of a spread illuminating apparatus according to a second embodiment of the present invention, and FIG. 9B is a cross-section view along line A-A of the spread illuminating apparatus shown in FIG. 9A;

FIG. 10 is a plan view illustrating the essential parts of an alternative embodiment of the spread illuminating apparatus according to the present invention; and

FIG. 11 is a plan view illustrating one example of a conventional narrow directivity spread illuminating apparatus.

### DETAILED DESCRIPTION OF THE PREFERRED EMBODIMENTS

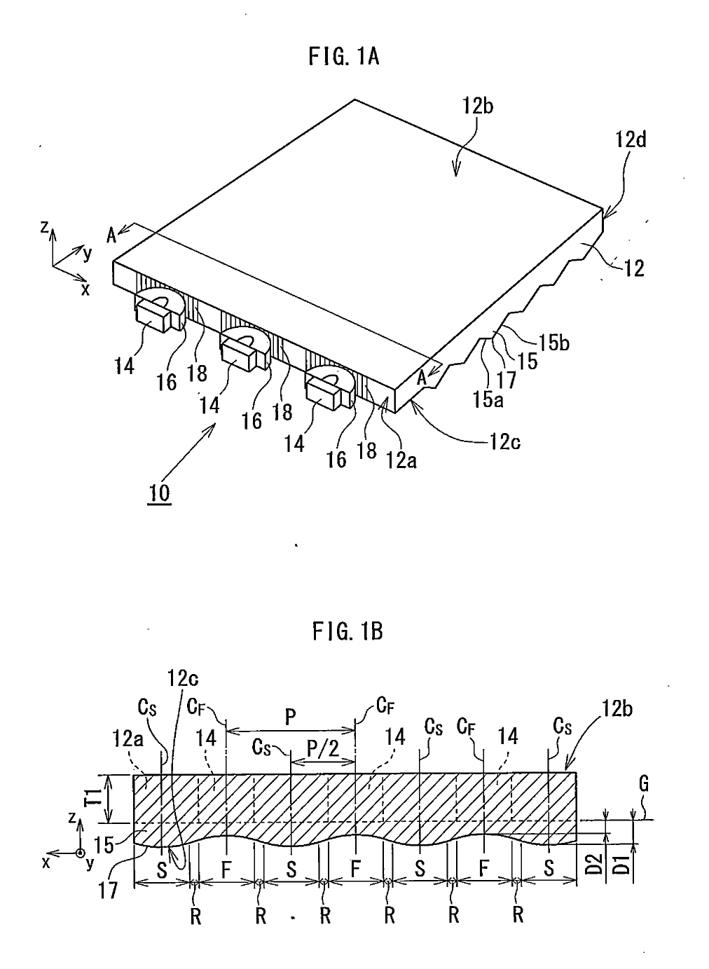

Embodiments of the present invention will be explained below referring to the drawings. The drawings illustrating all or part of the spread illuminating apparatus (FIGS. 1 to 3 and 8 to 10) are all schematic views in which the features are exaggerated for explanation and the relative dimensions of each illustrated part do not necessarily reflect the actual scale.

FIG. 1A is a perspective view illustrating the essential parts of a spread illuminating apparatus according to a first embodiment of the present invention.

The spread illuminating apparatus 10 shown in FIG. 1A is suitably utilized as a backlight for transmissive-type (or semi-transmissive type) liquid crystal display devices, and includes a light guide plate 12, three point light sources 14, and three brightness distribution control lenses 16 arranged between each point light source 14 and one side end surface 12a of the light guide plate 12. Each point light source 14 is disposed on an incident light surface 12a, which is one side end surface of the light guide plate 12, via the corresponding brightness distribution control lens 16.

In the present embodiment, the point light sources 14 consist of, for example, white light-emitting diodes. The light guide plate 12 is a plate-shaped light guide made by molding a transparent resin material such as a methacrylic resin or a polycarbonate resin. One principal surface of the light guide plate 12 is an emitting surface 12b that emits light which has entered from the point light sources 14 through the incident light surface 12a. In the light guide plate 12, the emitting surface 12b is a flat surface with no irregularities.

On the principal surface (hereinafter also referred to as an underside surface) 12c on the opposite side of the emitting surface 12b of the light guide plate 12, multiple prisms 15 are formed by arranging a plurality of prisms 15, which extends along a lengthwise direction (x direction) of the incident light surface 12a, in a direction (y direction) from the incident light surface 12a side toward an end surface 12d that opposes the incident light surface 12a. Each prism 15 has a pair of inclined surfaces 15a and 15b that is connected by a ridge line 17 of the prism 15, and the cross section orthogonal to the extension direction of each prism 15 forms a triangular shape.

In the spread illuminating apparatus 10, Fresnel lenses 18 are formed on the incident light surface 12a of the light guide plate 12. The spread illuminating apparatus 10 has a structure in which the brightness distribution control lenses 16 and the Fresnel lenses 18 are disposed in order from the point light sources 14 side. In FIG. 1A, the Fresnel lenses 18 are schematically illustrated by multiple solid line arrangement which extends in the thickness direction (z direction) of the light guide plate 12, and a detailed structure thereof will be explained later.

In the spread illuminating apparatus 10, an optical sheet such as a so-called prism sheet can be laminated and arranged on the emitting surface 12b side of the light guide plate 12, and a reflecting member for reflecting leaked light can be arranged on the underside surface 12c side of the light guide plate 12. In the spread illuminating apparatus 10, general components are usable for such constituent components, and illustration and explanation thereof will be thus omitted.

Next, referring to FIG. 1B, the structure of the prisms 15 will be explained. FIG. 1B is a cross-section view along line A-A of the spread illuminating apparatus 10 shown in FIG. 1A, and is specifically a view illustrating a cross section of the light guide plate 12 that is parallel to the incident light surface 12a and includes one ridge line 17 among the multiple prisms 15. In FIG. 1B, contours of the point light sources 14 arranged on the incident light surface 12a are indicated with dashed lines, and the brightness distribution control lenses 16 are omitted.

In the spread illuminating apparatus 10, the three point light sources 14 are arranged with a fixed pitch p along the lengthwise direction (x direction) of the incident light surface 12a. In FIG. 1B, a center position C_{F} of each point light source 14 with regard to the lengthwise direction (x direction) of the incident light surface 12a is shown with an alternate long and short dash line, and the center position C_{F} is also referred to as a front center in the explanation below.

In FIG. 1B, a center position C_{S} between two adjacent point light sources 14 (in other words, a position that is one half pitch p/2 from the center positions C_{F} of both of the two adjacent point light sources 14) is illustrated with an alternate long and short dash line. The alternate long and short dash line is also with the same reference numeral C_{S} to illustrate positions that are one half pitch p/2 from the center position C_{F} of each point light source 14 on the outside (the side at which no adjacent point fight source 14 exists) of the point light sources 14 that are at the outermost positions in the arrangement (in this example, the two point light sources 14 that are on both sides of the point light source 14 positioned at the center). In the explanation below, the center positions C_{S} including the two outermost positions are also referred to as a side center.

In the present invention, with regard to the constituent components of the light guide plate 12, a front portion of the point light source 14 indicates a portion corresponding to a prescribed range (for example, a range F shown in FIG. 1B) that includes the front center C_{F} of the point light source 14 with regard to the lengthwise direction of the incident light surface 12a of the light guide plate 12. A side portion of the point light source 14 indicates a portion corresponding to a prescribed range (for example, a range S shown in FIG. 1B) adjacent to both sides of the front portion F of the point light source 14.

However, the ranges F and S of the front and side portions shown in FIG. 1B are only one example thereof, and are not intended to limit the ranges in relation to, for example, the outer contour of the point light source 14. In the present invention, the range F of the front portion of the point light source 14 can be any appropriate range including the front center C_{F} of the point light source 14 depending on, for example, the optical and geometrical specifications of the spread illuminating apparatus 10. Similarly, the range S of the side portion of the point light source 14 can be any appropriate range as long as it is adjacent to the front portion of the point light source 14.

Below, the front portion and side portion of the point light source 14 of the constituent components (for example, the ridge lines 17 of the prisms 15) of the light guide plate 12 are explained with the symbols F and S which indicate the corresponding ranges.

In FIG. 1B, for explanatory convenience, the front center C_{F} of the point light source 14 is each illustrated as a geometric center of the outer contour of the point light source 14. However, in case that the position of the optical axis of the point light source 14 (normally a center axis of the light distribution of the emitted light) and the position at the geometric center of the outer contour do not match, the front center C_{F} may be determined based on the position of the optical axis.

Further, in the spread illuminating apparatus 10, the multiple prisms 15 are provided to protrude relative to a virtual plane G (hereinafter also referred to as a reference plane) that includes the long side on the underside surface 12c side of the incident light surface 12a of the light guide plate 12 and the long side on the underside surface 12c side of the side end surface 12d that opposes the incident light surface 12a. The distance between the ridge line 17 of the prism 15 and the reference plane G is referred to as the depth of the prism 15. Also, the distance between the emitting surface 12b of the light guide plate 12 and the reference plane G is referred to as the thickness of the light guide plate 12.

The dimension T1 shown in FIG. 1B indicates the thickness of the light guide plate 12 at the illustrated cross-section, and the dimensions D1 and D2 respectively indicate the locations of a maximum value and a minimum value of the depth of the prism 15 that changes spatially to be described later.

In the light guide plate 12 of the present embodiment, the dimension in the shorter direction (thickness direction) of the incident light surface 12a is equivalent to the dimension in the shorter direction (thickness direction) of the side end surface 12d, and the light guide plate 12 has a constant thickness entirely. Therefore, the thickness T1 of the light guide plate 12 shown in FIG. 113 is identical to the thickness of the incident light surface 12a.

However, in the present invention, the thickness of the light guide plate 12 is of course modifiable spatially from the incident light surface 12a side toward the side end surface 12d that opposes the incident light surface 12a (in other words, in the y direction). In this case, the thickness T1 of the light guide plate 12 in the cross-section of FIG. 1B should differ from the thickness of the incident light surface 12a.

In particular, the light guide plate 12 has, for example, a structure such as an inclined part near the incident light surface 12a that is not substantially used as an emitting part for illumination light. Thereby, a level difference exists between the thickness of the incident light surface 12a and the thickness of the light guide plate 12 at the emitting part. In case that such a level difference is formed on the underside surface 12c side (in other words, the surface on which the multiple prisms 15 are formed) of the light guide plate 12, the reference plane G is defined as a virtual plane that includes the long side on the underside surface 12c side of a cross section parallel to the incident light surface 12a at a start position (when viewed from the incident light surface 12a side) of the emitting part and the long side on the underside surface 12c side of the side end surface 12d, and the thickness of the light guide plate 12 at the emitting part is referred to simply as the thickness of the light guide plate 12.

In the spread illuminating apparatus 10, as shown in FIG. 1B, the multiple prisms 15 include prisms 15 whose depth changes spatially across the lengthwise direction (x direction) of the incident light surface 12a. The depth of such prisms 15 changes such that it becomes deeper at the side portions S of the point light sources 14 than at the front portions F of the point light sources 14. The inclination angles of the pair of inclined surfaces 15a and 15b that constitute each prism 15 relative to the reference plane G are both constant regardless of the depth of the prism 15 in the extension direction of the prism 15. Therefore, if the depth of the prism 15 changes in the extension direction of the prism 15, the length of the pair of inclined surfaces 15a and 15b respectively changes in proportion to the depth of the prism 15.

In the spread illuminating apparatus 10, the thickness T1 of the light guide plate 12 is constant across the lengthwise direction (x direction) of the incident light surface 12a within each cross section parallel to the incident light surface 12a. Thereby, the light guide plate 12 is constituted such that the ratio of the depth of the prism 15 shown in FIG. 1B relative to the thickness of the light guide plate 12 becomes larger at the side portions S than at the front portions F of the point light sources 14. In the example shown in FIG. 1B, the ratio of the depth of the prism 15 relative to the thickness of the light guide plate 12 reaches a maximum value (D1/T1) at the side center C_{S} of the point light sources 14 and reaches a minimum value (D2/T1) at the front center C_{F} of the point light sources 14.

Further, in the spread illuminating apparatus 10, as shown in FIG. 1B, it is preferable that the shape of the ridge line 17 at the front portion F of each point light source 14 is a curve having an extreme value at the front center C_{F}, and the shape of the ridge line 17 at the side portion S of each point light source 14 is a curve having an extreme value at the side center C_{S} in which the concave/convex parts of the curve are inversed compared to those of the extreme value at the front center C_{F}. It is also preferable that the curve at the front portion F and the curve at the side portion S are smoothly continuous at a transition portion R between the front portion F and the side portion S.

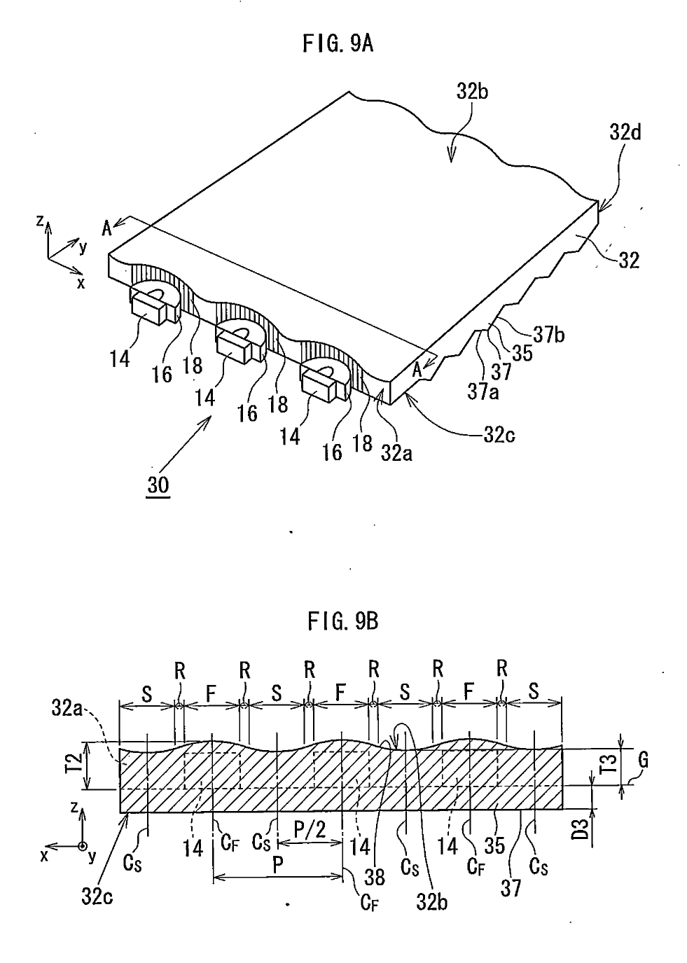

If expressed according to the z axis direction of the xyz coordinate system illustrated in FIG. 1B for explanation, the extreme values at the front center C_{F} and the side center C_{S} correspond respectively to a local maximum value and a local minimum value, and thus hereinafter the terms of local maximum value and local minimum value will be used with this meaning. The same applies to FIG. 9B.

In the spread illuminating apparatus 10, the ridge line 17 is more preferably formed in a sine curve shape that oscillates spatially in the thickness direction (z direction) of the light guide plate 12 along the lengthwise direction (x direction) of the incident light surface 12a of the light guide plate 12, in which the arrangement pitch p of the point light sources 14 is 1 period. The phase of the sine curve is constituted to have a local maximum value at the front center C_{F} and a local minimum value at the side center C_{S} as described above. Thereby, the depth of the prism 15, which is the distance between the reference plane G and the ridge line 17, also changes in a sine curve manner along the ridge line 17.

Among the multiple prisms 15 of the spread illuminating apparatus 10, all of the prisms 15 may consist of a prism 15 whose depth changes spatially as described above. Alternatively, the multiple prisms 15 can include both prisms 15 whose depth changes spatially as described above and prisms (similarly indicated by reference numeral 15) whose depth is constant. Here, in the arrangement of the multiple prisms 15, the prisms 15 whose depth changes spatially may be arranged on the incident light surface 12a side, and the prisms 15 whose depth is constant may be arranged on the side of the side end surface 12d that opposes the incident light surface 12a.

Further, in the spread illuminating apparatus 10, the multiple prisms 15 are formed on the underside surface 12c side of the light guide plate 12. However, in the spread illuminating apparatus according to the present invention, the multiple prisms 15 may be formed on the emitting surface 12b side. Here, since the structure of the multiple prisms 15 will be easily understandable by replacing the emitting surface 12b and the underside surface 12c by referring mainly to FIG. 1B, and thus such redundant explanations will be omitted.

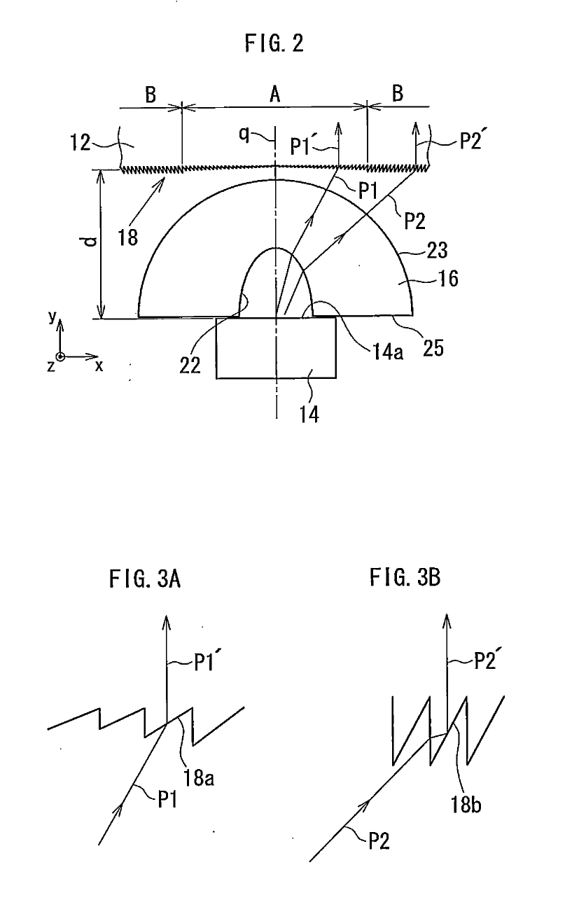

Next, referring to FIGS. 2 and 3, the structures of the brightness distribution control lens 16 and the Fresnel lens 18 of the spread illuminating apparatus 10 will be explained in detail.

In the spread illuminating apparatus 10, each Fresnel lens 18 is constituted as a so-called Fresnel-TIR compound Fresnel lens by arranging a plurality of unit prisms extending in the thickness direction (z direction) of the light guide plate 12 in the lengthwise direction (x direction) of the incident light surface 12a.

In detail, in the Fresnel lens 18, a prescribed range from the optical axis q (region A shown in FIG. 2; hereinafter also referred to as a region near the optical axis) is constituted as a linear Fresnel lens that realizes one curved surface of a cylindrical lens by assembling the refracting surfaces of the individual unit prisms, and the linear Fresnel lens has a light collecting operation similar to such a cylindrical lens. On the other hand, in the Fresnel lens 18, peripheral regions (regions B shown in FIG. 2) on the outside of the region A near the optical axis will conduct Total Internal Reflection (TIR) to lights that have been introduced into the unit of prism by means of a reflecting surface of the unit prism. Accordingly, the TIR lenses can well contribute to high light collecting effects by converting the optical path of introduced lights.

Each point light source 14 is disposed at the focal position of the Fresnel lens 18. The point light source 14 actually has a finite size, and thus the position of the point light source 14 in specific application situations is appropriately determined in accordance with the geometrical and optical characteristics of the point light source 14 to be used (for example, a white light-emitting diode) so that the light distribution of light emitted from the point light source 14 reaches a state that is as close as possible to the ideal light distribution from a point light source placed at the focal position of the Fresnel lens 18.

For example, the point light source 14 is arranged so that its optical axis corresponds to the optical axis q of the Fresnel lens 18 and a distance d from a predetermined reference plane with regard to the light distribution of the point light source 14 corresponds to the focal length of the Fresnel lens 18. As one example of such an arrangement, FIG. 2 illustrates an example in the case that the optical axis of the point light source 14 corresponds to the geometric center axis and the above-described reference plane with regard to the light distribution is an emitting surface 14a.

The brightness distribution control lens 16 positioned between the Fresnel lens 18 and the point light source 14 is made by providing one recessed portion 22 that penetrates in the thickness direction (center axis direction of the cylinder) to a flat surface part 25 of a half-cylinder shaped cylindrical lens. In the present embodiment, the recessed portion 22 is formed so that the shape of its cross section orthogonal to the thickness direction is a semi-ellipse. The brightness distribution control lens 16 is arranged so that a cylindrical surface 23 faces toward the light guide plate 12 side (and thus the flat surface part 25 is faced toward the point light source 14 side), its thickness direction corresponds to the thickness direction (z direction) of the light guide plate 12, and the center axis of the recessed portion 22 (the long axis of the ellipse in the example in FIG. 2) corresponds to the optical axis of the point light source 14 (and thus the optical axis q of the Fresnel lens 18).

In the spread illuminating apparatus 10, the ranges of the region A near the optical axis and the peripheral regions B of the Fresnel lens 18 as well as the shapes of the brightness distribution control lens 16 and the recessed portion 22 are appropriately determined in accordance with the geometrical and optical characteristics and the like of the point light source 14 to be used as long as they achieve the operational effects described below.

FIG. 1 illustrates an embodiment in which the Fresnel lenses 18 are formed locally at respective locations opposing the point light sources 14 on the incident light surface 12a of the light guide plate 12. However, the Fresnel lenses 18 may be provided continuously, and such a continuous Fresnel lens 18 may be formed across the entire surface of the incident light surface 12a of the light guide plate 12.

With the arrangement described above, in the spread illuminating apparatus 10, light emitted from each point light source 14 enters the brightness distribution control lens 16 along typical optical paths as shown by P1 and P2 in FIG. 2, and then propagates upon increasing the spread angle within a plane that is orthogonal to the thickness direction of the brightness distribution control lens 16 (and thus the thickness direction (z direction) of the light guide plate). Next, the light enters the Fresnel lens 18 and progresses through the light guide plate 12 as parallel light P1′ and P2′ within a plane (xy plane) orthogonal to the thickness direction of the light guide plate 12.

At this time, since the Fresnel lens 18 in the present embodiment is constituted as a Fresnel-TIR compound Fresnel lens as described above, the optical path of the light P1 that has reached the region A near the optical axis is mainly converted by the refracting operation of a refracting surface 18a as shown in FIG. 3A, and the optical path of the light P2 that has reached the peripheral region B is mainly converted by total internal reflection by a reflecting surface 18b as shown in FIG. 3B.

Light which has entered into the inside of the light guide plate 12 through the incident light surface 12a propagates through the light guide plate 12 toward the side end surface 12d side (in the y direction) while repeating total reflection between the emitting surface 12b and the underside surface 12c. In this process, a portion of the propagated light enters the inclined surfaces 15a and 15b of the multiple prisms 15 formed on the underside surface 12c, and thus the optical path of this light is converted by reflection and enters the emitting surface 12b at an incident angle that is smaller than a critical angle. Thereby, the light is emitted from the emitting surface 12b as illumination light. The spread illuminating apparatus 10 thereby illuminates an object to be illuminated such as a liquid crystal panel by uniformly emitting illumination light from the emitting surface 12b.

Next, operational effects of the spread illuminating apparatus 10 constituted as described above will be explained.

First, in the spread illuminating apparatus 10, through the operation of the Fresnel lens 18, the light distribution in a direction parallel to the lengthwise direction of the incident light surface 12a (in other words, within the xz plane) of emitted light (illumination light that is illuminated on the object to be illuminated) that is emitted from the emitting surface 12b of the light guide plate 12 can be narrowed. For example, in a spread illuminating apparatus in which a normal prism sheet is disposed on the emitting surface 12b side of the light guide plate 12 and no Fresnel lens 18 is provided, in the case that the half-value width of the light distribution within the xz plane is approximately 40°, the half-value width can be narrowed to approximately 20° by providing a Fresnel lens 18 to the same spread illuminating apparatus.

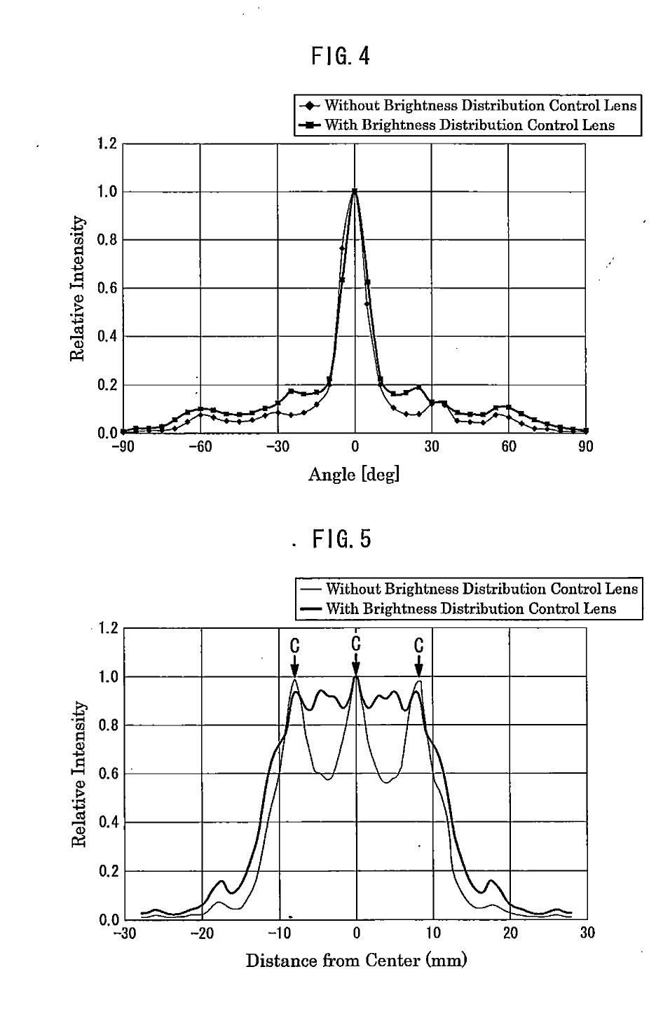

Operational effects of the brightness distribution control lens 16 in the spread illuminating apparatus 10 will now be explained referring to FIGS. 4 and 5. FIG. 4 illustrates the directivity of emitted light within the xz plane. The horizontal axis is the angle from a direction in which the emitted light intensity reaches a peak value, and the vertical axis is a relative intensity of the emitted light relative to the peak value. FIG. 5 illustrates the brightness uniformity of emitted light from the emitting surface 12b near the incident light surface 12a of the light guide plate 12. The horizontal axis is the distance along the lengthwise direction of the incident light surface 12a (in other words, the pitch direction of the arrangement of the point light sources 14) from the point light source placed at the center among the three point light sources 14, and the vertical axis is the relative intensity of the emitted light relative to the peak value.

FIGS. 4 and 5 are graphs of a spread illuminating apparatus with the Fresnel lens 18 in case of “with” the brightness distribution control lens 16 and “without” the brightness distribution control lens 16.

First, it can be understood in FIG. 4 that there is not much difference in the spread between the light distribution in the case that the brightness distribution control lens 16 exists and the case in which it does not, and the brightness distribution control lens 16 does not influence the narrow directivity achieved by the Fresnel lens 18. On the other hand, in FIG. 5, it can be understood that in the emitting surface 12b near the incident light surface 12a of the light guide plate 12, dark parts, in which the intensity greatly decreases between the peak values (shown by the arrows C in FIG. 5) corresponding to the positions at which the point light sources are arranged, exist when the brightness distribution control lens 16 does not exist. In this case, remarkable unevenness in the brightness occurs. On the other hand, there can be found no dark parts when the brightness distribution control lens 16 exists. In this case, the brightness is uniform.

Accordingly, in the spread illuminating apparatus 10 according to the present embodiment, illumination fight with narrow directivity and excellent brightness uniformity can be obtained. Further, by constituting the Fresnel lens 18 with a Fresnel-TIR compound Fresnel lens, the transmission at the peripheral regions B is improved compared to a simple Fresnel lens, and the brightness of the illumination light becomes more effectively uniform.

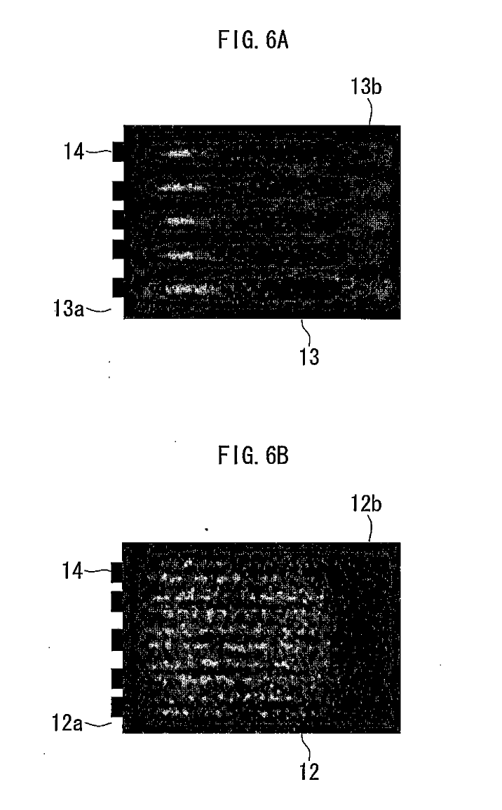

In the spread illuminating apparatus 10, multiple prisms 15 contain certain prisms 15 whose height changes as shown in FIG. 1 B. Operational effects thereof will be explained referring to FIG. 6.

In FIG. 6A, regarding a spread illuminating apparatus of a comparative example, the brightness distribution on an emitting surface 13b of a light guide plate 13 is indicated by shade distributions. On the other hand, in FIG. 6B, regarding the spread illuminating apparatus 10 according to the first embodiment of the present invention, the brightness distribution on the emitting surface 12b of the light guide plate 12 is indicated by shade distributions.

The structure of the spread illuminating apparatus of the comparative example is the same with the one of the spread illuminating apparatus 10 except that all of the multiple prisms formed on the underside surface side of the light guide plate 13 have a constant depth across their extension direction.

In FIGS. 6A and 6B, the regions that are the lightest (hereinafter also referred to as highlight regions) represent regions in which the brightness is the highest, and regions which are adjacent to the periphery of the highlight regions and are darker than the highlight regions represent regions in which the brightness is lower than in the highlight regions. The level of the shade and the level of the brightness do not necessarily have a fixed relationship (for example, the darker the region the lower the brightness) across the entire diagram, but at the very least, regions in which the shade is different correspond to regions in which the brightness is different.

In FIGS. 6A and 6B, the brightness distribution control lens 16 is omitted, and the arrangement of the point light sources 14 is schematically represented along the respective incident light surfaces 13a and 12a.

As explained above referring to FIGS. 4 and 5, in a spread illuminating apparatus including the Fresnel lens 18, the narrow directivity achieved by the Fresnel lens 18 is not influenced by the addition of the brightness distribution control lens 16, in return at least the uniformity of the brightness of the emitting surface 12b near the incident light surface 12a of the light guide plate 12 can be greatly improved.

However, through effortful investigation and research by the present inventors, when focusing on the brightness across the entire emitting surface, it has been discovered that in the spread illuminating apparatus of the comparative example as shown in FIG. 6A, there are cases in which unevenness in the brightness occurs in which the brightness at the front portions of the point light sources 14 of the light guide plate 13 is high and the brightness at the side portions is low.

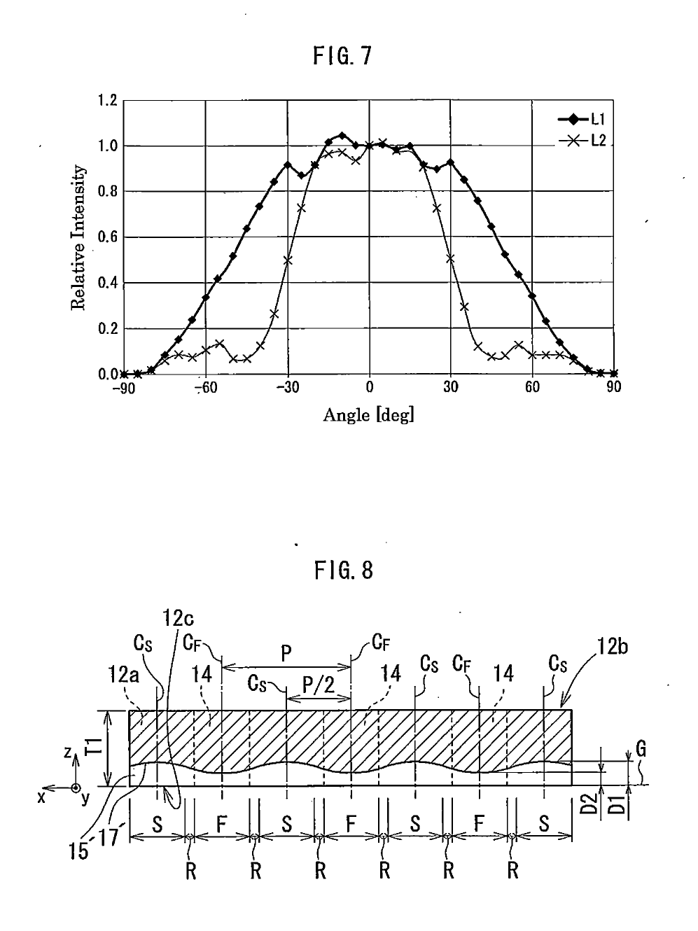

Further, by a detailed analysis regarding the light distribution of light that has been introduced into the light guide plate 12 via the brightness distribution control lens 16 and the Fresnel lens 18, the present inventors have found that there is a difference as shown in FIG. 7 in the light distribution in the thickness direction of the light guide plate 12 between light that enters from the front portion of the point light source 14 (near the optical axis of the point light source 14) of the incident light surface 12a (hereinafter also referred to as front light) and light whose optical path is converted to a wide angle from the optical axis within a plane that is orthogonal to the thickness direction of the brightness distribution control lens 16 and then enters from the side portion of the point light source 14 (for example, F2′ shown in FIG. 2; hereinafter also referred to as side light) of the incident light surface 12a. This difference could be at least one factor causing the unevenness in the brightness shown in FIG. 6A.

FIG. 7 illustrates the light distribution in the thickness direction of the light guide plate 12 of the front light L1 and the side light L2.

As can be understood from FIG. 7, the light distribution of the side light L2 in the thickness direction of the light guide plate 12 is narrower than the light distribution of the front light L1 in the thickness direction of the light guide plate 12. Therefore, in the light guide plate 13 of the comparative example, among light that advances through the light guide plate, the amount of side light that enters the multiple prisms formed on the underside surface side of the light guide plate 13 is lower than the amount of front light, and it is determined that this causes the unevenness in the brightness as shown in FIG. 6A.

However, in the spread illuminating apparatus 10 according to the present embodiment, the multiple prisms 15 include prisms 15 formed so that the ratio of the depth of the prism 15 relative to the thickness of the light guide plate 12 becomes larger at the side portions S than at the front portions F of the point light sources 14. Thereby, among light that is reflected by the prisms 15 and then emitted from the emitting surface 12b, the proportion of the amount of light from the side direction relative to the amount of light from the front direction increases, and thus the uniformity of emitted light can be improved across the entire emitting surface 12b as shown in FIG. 6B.

By making the spatial change in the depth of the prisms 15 to follow a sine curve shape, non-continuous or excessively large changes in the depth of the prisms 15 do not occur in the boundary between the front portions F and the side portions S of the point light sources 14. Therefore, unevenness in the brightness caused by such changes does not occur, and the uniformity of the emitted light can be further improved.

In the example shown in FIG. 1, the prism 15 has a ridge line 17 that protrudes from the reference plane G. However, in the spread illuminating apparatus 10, at least a portion of the multiple prisms 15 can be constituted so that they are recessed relative to the reference plane G and have a cross section orthogonal to the extension direction that is a triangular groove. In this case, as shown in FIG. 8, the depth from the reference plane G of at least a portion of the prisms 15′ among the prisms that are recessed can change spatially across the lengthwise direction (x direction) of the incident light surface 12a so that it becomes deeper at the side portions S of the point light sources 14 than at the front portions F of the point light sources 14.

With regard to the prisms 15′ that are recessed relative to the reference plane G, the distance between the ridge line 17′ and the reference plane G is called the depth of the prism 15′. Similar to FIG. 1B, the dimensions D1 and D2 shown in FIG. 8 respectively indicate the locations of a maximum value and a minimum value of the depth of the prism 15′ that changes spatially.

Accordingly, the prism 15′ shown in FIG. 8 is constituted such that the ratio of the depth of the prism 15′ relative to the thickness of the light guide plate 12 becomes larger at the side portions S than at the front portions F of the point light sources 14. The multiple prisms 15 that include such prisms 15′ achieve the same operational effects with those of the multiple prisms 15 including the prisms 15 as shown in FIG. 1B.

In the example shown in FIG. 8, similar to the prism 15 shown in FIG. 1B, the ratio of the depth of the prism 15′ relative to the thickness of the light guide plate 12 reaches a maximum value (D1/T1) at the side center C_{S} of the point light sources 14 and reaches a minimum value (D2/T1) at the front center C_{F} of the point light sources 14. However, in case that the ridge line 17′ of the recessed prism 15′ is constituted in a sine curve shape, the phase of the sine curve has a local minimum value at the front center C_{F} and a local maximum value at the side center C_{S}, which is different from the ridge line 17 shown in FIG. 1B.

Next, referring to FIG. 9, a spread illuminating apparatus 30 according to a second embodiment of the present invention will be explained. With regard to the spread illuminating apparatus 30, components that are the same with those of the spread illuminating apparatus 10 shown in FIG. 1 will be assigned the same reference numerals and explanations of redundant portions will be omitted, and thus the explanation will focus mainly on the points of difference from the spread illuminating apparatus 10.

In the spread illuminating apparatus 30 according to the present embodiment, multiple prisms 35 formed on an underside surface 32c of a light guide plate 32 all have a constant depth D3 (refer to FIG. 9B) along their extension direction (x direction), and the light guide plate 32 is constituted so that its thickness changes spatially across the lengthwise direction (x direction) of the incident light surface 32a due to the concave/convex structure of an emitting surface 32b.

In detail, as shown in FIG. 9B, the thickness of the light guide plate 32 changes so that the light guide plate becomes thinner at the side portions S of the point light sources 14 than at the front portions F of the point light sources 14 along a ridge line 37 of the prism 35 in a cross section of the light guide plate 32 that is parallel to the incident light surface 32a and includes one ridge line 37 among the multiple prisms 35 (in FIG. 9B, the thickness of the light guide plate 32 in the illustrated cross section is illustrated to show the locations where it reaches a maximum value T2 and a minimum value T3).

In the spread illuminating apparatus 30, the light guide plate 32 is constituted as that the ratio of the depth of the prism 35 shown in FIG. 9B relative to the thickness of the light guide plate 32 becomes larger at the side portions S than at the front portions F of the point light sources 14 due to the spatial changes in the thickness of the light guide plate 32. In the example shown in FIG. 9B, the ratio of the depth of the prism 35 relative to the thickness of the light guide plate 32 reaches a maximum value (D3/T3) at the side center C_{S} of the point light sources 14 and reaches a minimum value (D3/T2) at the front center C_{F} of the point light sources 14.

In the spread illuminating apparatus 30, the shape of the emitting surface 32b of the light guide plate 32 is preferably constituted so that the contour of a cutting plane line 38 at the front portion F of each point light source 14 is a curve having a local maximum value at the front center C_{F}, and the contour of the cutting plane 38 at the side portion S of each point light source 14 is a curve having a local minimum value at the side center C_{S}, and the curve at the front portion F and the curve at the side portion S are smoothly continuous at a transition portion R between the front portion F and the side portion S.

Similarly, in the spread illuminating apparatus 30, it is further preferable for the emitting surface 32b of the light guide plate 32 to be constituted so that the cutting plane line 38 is formed in a sine curve shape that oscillates spatially in the thickness direction (z direction) of the light guide plate 32 along the lengthwise direction (x direction) of the incident light surface 32a of the light guide plate 32, in which the arrangement pitch p of the point light sources 14 is 1 period. The phase of the sine curve is constituted to have a local maximum value at the front center C_{F} and a local minimum value at the side center C_{S} as described above. Thereby, the thickness of the light guide plate 32, which is the distance between the reference plane G and the emitting surface 32b, also changes in a sine curve fashion along the ridge line 37 of the prism 35.

FIG. 9A illustrates an example in case that the emitting surface 32b of the light guide plate 32 changes spatially as described above across the entire area of the emitting surface 32b along a direction (y direction) from the incident light surface 32a toward the side end surface 32d that opposes the incident light surface 32a. However, the spread illuminating apparatus 30 according to the present embodiment can be constituted so that only a part of the emitting surface 32b of the light gtiide plate 32 among the portion opposing the multiple prisms 35 changes as described above along the ridge line 37 of the prism 35.

For example, the emitting surface 32b of the light guide plate 32 can be constituted so that a part of the emitting surface 32b that faces the prism 35 arranged on the incident light surface 12a side in the arrangement of the multiple prisms 35 changes as described above along the ridge line 37 of that prism 35, and a part of the emitting surface 32b that faces the prism 35 arranged on the side of the side end surface 12d that opposes the incident light surface 12a is a flat surface.

With the above structure, the spread illuminating apparatus 30 according to the present embodiment achieves the same operational effects with those of the spread illuminating apparatus 10.

In the spread illuminating apparatus 30, at least a portion of the multiple prisms 35 may be constituted so that they are recessed relative to the reference plane and have a cross section orthogonal to the extension direction that is a triangular groove. Also, in the spread illuminating apparatus according to the present invention, the spread illuminating apparatus 30 is similar to the spread illuminating apparatus 10 in that it also includes a structure in which the multiple prisms 35 can be formed on the emitting surface 32b side and the underside surface 32c changes spatially as described above.

Preferred embodiments of the present invention were explained above, but the spread illuminating apparatus according to the present invention is not limited to the above embodiments.

For example, the spread illuminating apparatus according to the present invention may include both the features of the multiple prisms 15 in the spread illuminating apparatus 10 according to the first embodiment described above as well as the features of the emitting surface 32b of the light guide plate 32 in the spread illuminating apparatus 30 according to the second embodiment described above.

Also, in the above-described embodiments, the Fresnel lens 18 is formed integrally with the light guide plate 12, 32 on the incident light surface 12a, 32a of the light guide plate 12, 32. However, the Fresnel lens 18 may be formed separately from the light guide plate 12, 32 and arranged between the brightness distribution control lens 16 and the incident light surface 12a, 32a of the fight guide plate 12, 32.

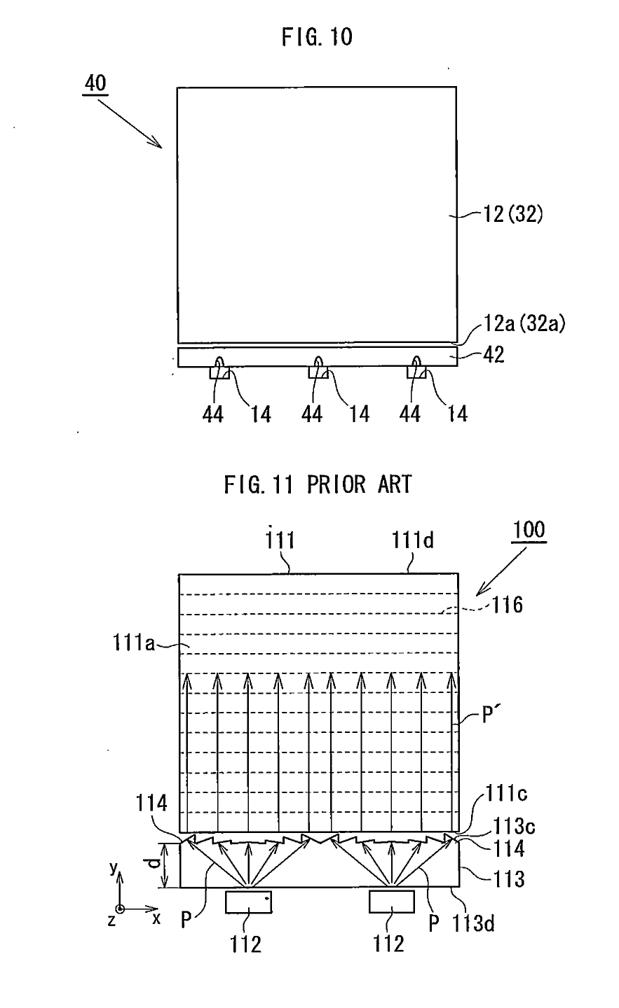

Further, as in a spread illuminating apparatus 40 shown in FIG. 10, a brightness distribution control lens 42 may be formed as an integral rectangular column that has a recessed portion 44 provided at each LED 14. In this case, compared to the case where the brightness distribution control lens 16 is provided for each LED lens, there is no loss of light due to light that enters the gaps between the brightness distribution control lenses 16, and thus the light use efficiency can be improved.

What is claimed is:

1. A spread illuminating apparatus comprising:
a point light source;
a light guide plate having an incident light surface on which the point light source is arranged and an emitting surface that emits light;
a brightness distribution control lens that controls a spread angle of light emitted from the point light source; and
a Fresnel lens that adjusts the spread angle making light to advance along an optical axis in the light guide plate,
wherein multiple prisms extend along a lengthwise direction of the incident light surface and are formed on the emitting surface of the light guide plate or a surface opposite to the emitting surface, and
at least some certain prisms in the multiple prisms are configured as that a ratio of the prism depth relative to the thickness of the light guide plate is adapted to be larger at a side portion of the point light source than at a front portion of the point light source.

2. The spread illuminating apparatus according to claim 1, wherein the multiple prisms contain at least some certain prisms whose depth changes to satisfy that a side portion of the point light source is adapted to be deeper than a front portion of the point light source.

3. The spread illuminating apparatus according to claim 2, wherein the change in the prism depth forms a sine curve.

4. The spread illuminating apparatus according to claim 1, wherein the thickness of the light guide plate changes along a ridge line of the prism to satisfy that a side portion of the point light source is adapted to be thinner than a front portion of the point light source.

5. The spread illuminating apparatus according to claim 4, wherein the change in the thickness of the light guide plate along the ridge line of the prism forms a sine curve.

6. The spread illuminating apparatus according to claim 1, wherein the brightness distribution control lens each has one recessed portion which penetrates in the thickness direction of the brightness distribution control lens, the recessed portion being located at a place facing the point light source.

7. The spread illuminating apparatus according to claim 6, wherein a cross section of the recessed portion orthogonal to the thickness direction of the brightness distribution control lens forms a semi-ellipse, and a center axis of the recessed portion corresponds to an optical axis of the point light source.

8. The spread illuminating apparatus according to claim 1, wherein the Fresnel lens is formed on the incident light surface of the light guide plate.

9. The spread illuminating apparatus according to claim 1, wherein the Fresnel lens is a Fresnel-TIR compound Fresnel lens.
